(19) United States
(12) Patent Application Publication
(10) Pub. No.: US 2013/0014369 A1
(43) Pub. Date: Jan. 17, 2013

(54) DEVICE AND METHOD FOR THE ROTATIONAL ORIENTATION OF A TUBE HEAD RELATIVE TO A TUBE BODY

(71) Applicant: Oskar Schulthess, Jona (CH)

(72) Inventor: Oskar Schulthess, Jona (CH)

(73) Assignee: PACKSYS GLOBAL (SWITZERLAND) LTD., Rueti (CH)

(21) Appl. No.: 13/637,158

(22) PCT Filed: Mar. 17, 2011
(86) PCT No.: PCT/EP11/01327

§ 371 Date: Sep. 25, 2012

(30) Foreign Application Priority Data
Mar. 25, 2010 (DE) 102010012858.9

(51) Int. Cl. B67B 3/26

(52) U.S. Cl. 29/407.1; 29/714

(57) ABSTRACT

A device for the automatic rotational orientation of a tube head (16) relative to a preferably stationary tube body (14), wherein the device has a sensor (18) for sensing a current rotated position of the tube head or tube body having a position indicator (21), the device further includes a positioning device (12, 20) which interacts with the sensor and is designed to effect a rotary movement of the tube head or of the tube body in reaction to a control signal from a control unit (22). The sensor is designed to generate a sensing signal corresponding to a rotary moment of the tube head or tube body and the control unit correlates the sensing signal with a reference signal and for generating a control signal from a characteristic value corresponding to a degree of correlation, in particular a maximum correlation or minimum correlation, for the positioning device.

### BACKGROUND OF THE INVENTION

The instant invention relates to a device for the automatic rotational orientation of a tube head relative to a tube body according to the preamble of the main claim as well as to a method for the rotational orientation, in particular for the operation of such a device.

There is a need in the state of the art, in particular in the context with the tube production in the food or cosmetic field, to orient a tube head (typically provided in the manner of a cap) in a predetermined direction of rotation to the tube body (having a flat or oval cross section, respectively). A typical example for this is, for example, the orientation of a grip area provided on the tube head for an imprinting on the flat side of the corresponding tube body, wherein the desired positive optical impression is attained when this grip section is oriented approximately centrally to the typeface. It is necessary for this to carry out an orientation of the tube head in the desired manner prior to the (typically automated) attaching of the tube head onto the tube body.

It is thereby known from the state of the art to use light barrier-based solutions. This process is explained using the example of FIG. 6 of the state of the art. A divided tube head 16 (typically comprising a cap 17, which is connected via a foil hinge, as is shown in FIG. 7), which must be rotationally oriented as intended, encompasses a basic cylindrical contour and forms a contact section 21 for the manual actuation, which appears as a flat area in the top view of FIG. 6.

This deviation from a pure rotational symmetry uses the known technology in that this section is sensed by means of a laser beam (within an optical light barrier design) like a position indicator and the correct rotated position can thus be determined. FIG. 6 clarifies an idealized signal sequence of this light barrier sensor.

In the further processing, the state of the art then provides for a compensation of the tube head position obtained in this manner with the position of the tube body to take place, a servo motor, which effects the orienting rotary movement, to be controlled in a suitable manner and for the tube head to be subsequently pressed (as cap) onto the tube body in a manner known per se.

However, such an idealized signal sequence can rarely be obtained in production practice. In addition, different types of tubes often also make different demands on the sensing of a position indicator (the latter is thus often not present or only poorly in the manner of the flat area shown in FIG. 6, but for instance as a hinge or the like, which is difficult to detect). The known technology often also reacts sensitively to (intentional or unintentional) deviations from an ideal peripheral shape; for instance, caps, which are centered poorly or which are produced with a tolerance, can lead to a faulty detection, in the same way as an oval cross sectional shape of a tube head leads to difficulties of an accurate position determination in the above-described procedure. Accordingly, an increased adjusting, calibration and evaluation effort is thus necessary in the case of known procedures, with the associated disadvantages for quick clock times, short retrofitting times or low error or reject rates, respectively.

A device comprising the features of the preamble of the main claim is known from JP 2000 327086 A. With regard to the further state of the art as background, reference is to be made to CH 22: “Sampling and Filtering of Continuous Measurements” in: Dale Seborg, Tom Edgar, and Duncan Mellichamp: “Process Dynamics and Control”.

It is thus the object of the instant invention to improve a device for the rotational orientation of a tube head relative to a tube body in view of a simplified and more reliable position sensing of a tube head, with the purpose of providing a simpler and faster joining of tube head and tube body as result of the position sensing. A change of different tube head types is to also be possible more easily and without increased calibration effort, and an improved error and reject rate in the automated tube production, in particular in the automated, oriented joining of tube head and tube body, can be attained on principle.

### SUMMARY OF THE INVENTION

The object is solved by providing a device and method wherein the sensor means for sensing a current rotated position of the tube head are designed in an advantageous manner according to the invention such that they output a sensing signal, which corresponds to a rotary movement of the tube head and such that this sensing signal is subsequently correlated with a reference signal. An absolute rotated position of the desired position indicator (thus typically of the grip section or of a hinge) can thus be determined from this correlation result in a highly reliable and interference-insensitive manner, whereby the accurate subsequent orientation for each rotary movement can then take place again.

Provision is thereby made within the context of the invention for the reference signal (for instance in the context of the same technical arrangement) to be determined on a reference object (for instance an idealized tube head), which is positioned in a suitably predetermined manner or which is stationary in its relative position to a tube head. In addition it is possible to access a predetermined reference signal (for instance existing as predetermined data set in a suitable electronically stored form), wherein it is also advantageous in particular, to store the respective data sets for quick access for a plurality of different tube head types, which are to be used or positioned, respectively, in a system in each case.

Even though the execution of a rotary movement on the tube head is intended in the context of the solution according to the invention in the manner of a preferred embodiment, the invention, however, also includes and makes it possible to realize the relative rotary movement according to the invention between tube head and tube body in that, in the case of a rotationally fixed tube head, the tube body, which is to be oriented relative thereto, is rotated into the suitable position. The entire description at hand can thus be applied or suitably adapted, respectively, analogous to this possible invention constellation.

It is preferred in the context of the invention to record the sensing signal, which is created according to the invention, as a time-dependent signal, wherein the time sequence corresponds to the rotary movement. The sensor means themselves can be chosen arbitrarily, ideally in correspondence with the detection demands for a respective tube head, and can be optical sensors (thus for instance light barriers, image recording sensors or others), sensors or ultrasound sensors acting inductively or capacitively, as long as a position indicator can be sensed suitably on the tube head.

The sensing signal recorded according to the invention as continuous signal (or as sequence of suitable discrete or suitably quantified individual signals, respectively), is then correlated with the reference signal in a manner known per se, wherein the result of the correlation is a functional context (typically along the time sequence), which embodies a functional maximum. This functional maximum and the position thereof (for instance in the chronological sequence) is then the basis for the determination of the searched relative rotated position of the tube head to be measured and the basis for the subsequent rotational positioning of the tube head relative to the tube body into the desired orientation position. The term “functional maximum” is thereby not to be understood as being limiting for the invention.

Instead, it is similarly possible to identify another characteristic value, which is characteristic for the correlation, or a variable along the correlation function, respectively, for instance a minimum correlation, from which the desired control signal for the rotary movement, which is to be carried out, can also be derived. A “correlation” in the context of the instant invention is thereby not necessarily an operation, which allocates a complete gradient (corresponding to a rotation). Instead, a (suitably chosen) section of this correlation according to the invention can also form the basis.

While it is preferred on the one hand in the context of the invention to carry out the correlation according to the invention on the basis of a (limited) number of discrete individual values of the sensing signal (or of the reference signal, respectively), wherein at least 10 individual values should be correlated to reach a desired positional accuracy in the context of a preferred further development of the invention, the invention similarly includes to carry out the correlation of the basis of analog signal sequences. Generally, it is an optimization problem between the required calculating effort (which in turn is a function of the number of the correlated individual signals or the resolution of the functions, which are to be observed, respectively) and of the desired resolution accuracy in the direction of rotation, so as to obtain an intended process speed, which is as high as possible, with a simultaneous position detection, which is as accurate as possible.

As a result, the instant invention provides for the realization of a sensing of a rotated position of a tube head (or of a tube body, respectively), in a surprisingly simple manner, with the possibility of being able to quickly effect a subsequent automatic joining of the tube head with a tube body in an oriented manner, with a low reject rate and in a flexible manner.

### BRIEF DESCRIPTION OF THE DRAWINGS

Further advantages, features and details of the invention follow from the subsequent description of preferred exemplary embodiments as well as by means of the drawings.

FIG. 1 shows a schematic block diagram of the device for the automatic rotational orientation of a tube head relative to a tube body in a machine context according to a first preferred embodiment of the invention;

FIG. 2 shows a schematic diagram for clarifying the sensing according to the invention of a current rotated position of a tube head by means of the sensor means in the form of a continuously sensed rotation;

FIG. 3a, FIG. 3b show measuring values of a simplified example listed in table form as well as a corresponding diagram in the elapsed time for a reference curve of a reference tube head (3a) or a measured idealized tube head (3b), respectively;

FIG. 4 shows a list of the correlation coefficients determined from a correlation of the test series according to FIGS. 3a, 3b, as well as the maximum correlation, which can be identified therein;

FIG. 5a, FIG. 5b show modifications of the test series according to FIG. 3b with measuring errors or measuring values, which deviate from the ideal measuring value sequence, respectively, and the impact thereof on the correlation to clarify the error tolerance of the instant invention;

FIG. 6 shows a schematic illustration for clarifying a light barrier sensing for the tube head position determination from the state of the art and

FIG. 7 shows an illustration of a tube head comprising a contact area as position indicator of the tube head.

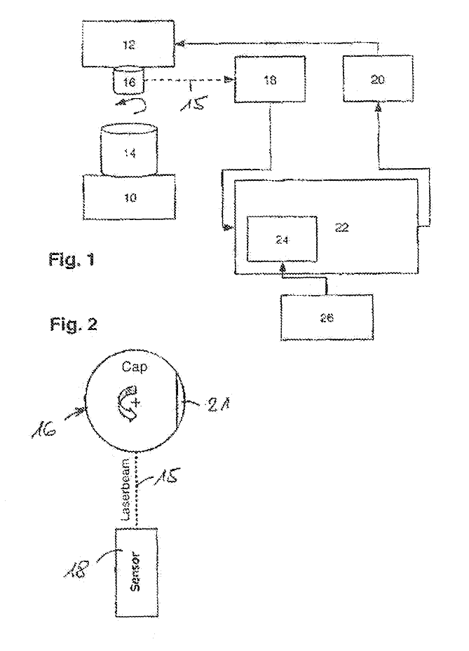

### DETAILED DESCRIPTION

The schematic block diagram of FIG. 1 clarifies the essential functional components of a device for the automatic rotational orientation of a tube head relative to a stationary tube body according to a first preferred exemplary embodiment of the instant invention.

The functional block 10 thereby schematically clarifies a (static) holder for a tube body, which is held in a corresponding rotationally positionally fixed manner. A tube head 16, which is held as positioning means in a suitable orientation and drive unit 12 so as to be rotationally movable relative to said tube body, can be rotated about a (vertical) axis of rotation such that the tube head 16 can be positioned in a predetermined rotated position to the tube body 14 and can be attached subsequently in this position. In the shown exemplary embodiment, the tube head is made in two parts consisting of cover section 17 and outlet section 19 with foil hinge located therebetween (not illustrated) in the manner shown in more detail in FIG. 7; a grip section 21 for opening the cover similarly serves as position indicator.

The positioning means 12, substantially encompassing a suitably connected rotary drive (not shown) are designed to set the tube head 16 (cap) into a rotary movement in the manner shown in FIG. 1, wherein the lateral contour (jacket) is scanned continuously by a laser-based sensor unit 18.

The correspondingly digitized or quantified signal, respectively, of the sensor 18 (obtained from the laser beam 15, which is continuously reflected on the jacket of the tube head), is then processed by a central control and processing unit 22, is in particular correlated with reference data in a manner, which will be described below, wherein a control signal for drive or driver means 20, respectively, is then obtained from the result, which, in turn, shift the positioning means 12 into the desired rotated position, as explained above.

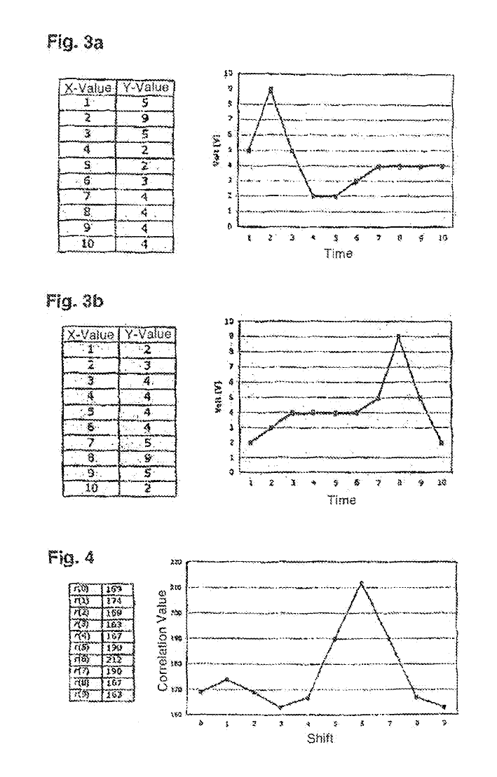

This procedure is to be explained below by means of the signal tables and time sequence diagrams of FIGS. 3a, 3b and 4, which have been chosen in an exemplary manner and which are simplified for explanation purposes.

The signal level sequence “Y value” of FIG. 3b, plotted over time (as X value and corresponding to a complete rotation of the tube head (cap) 16) thus corresponds approximately to a typical signal sequence, as it appears in the case of a cap of the type shown in FIG. 7: the opening section 21 generates the signal maximum (level V) at the point in time 8; in contrast, the measuring values located outside of this area 21 encompass a considerably lower amplitude (level between 2 and 4V).

The signal sequence of FIG. 3a, used in the instant case as reference signal sequence and obtained by scanning a reference pattern (or an idealized body, the rotated position of which is known, respectively) in the instant case corresponds exactly with the signal sequence of FIG. 3b in view of the level sequence, only shifted by six time values (that is, at the point in time t=2, the amplitude maximum of the Y value in FIG. 3a thus lies six time units ahead of the actually measured value of FIG. 3b).

In an advantageous manner according to the invention, a correlation calculation is now carried out for the data, which are present numerically in the shown manner (because they are obtained by the sensor unit 18 and because they are suitably quantified), according to the approach of the so-called discrete correlation, wherein a correlation coefficient r(n) is calculated as follows for each of the points in time n=0 to 10:

r(n)=Σx(m)y(m+n), summed via m=−α to +α
here: m=1 to 10 (number of the measuring values)
wherein n=0 . . . 9, in accordance with the points in time 1 to 10 (FIG. 3a or 3b, respectively)
and
x( ) represents the first test series (for instance in accordance with FIG. 3a) and y( ) represents the second test series (FIG. 3b).

This correlation calculation results in the correlation coefficients, which are listed in table form in FIG. 4 for the values n=0 to n=9 as well as in the graphic illustration thereof.

It is shown that the sequence of the correlation values (FIG. 4) encompasses a clearly identifiable maximum for n=6, with the immediately apparent or readable meaning, respectively, that (see the curve sequences of FIG. 3a relative to FIG. 3b) the largest correspondence is present between the curve sequences when the curves, which are to be compared (FIGS. 3a and 3b), are shifted by six time units; this would then exactly lead to the identity in this idealized case.

In this respect, the maximum correlation of FIG. 4, which can be identified, provides information in the instant case, how the tube head 16 must be rotated relative to the stationary tube body 14 by means of the units 12 or 20, respectively, so as to be obtain the desired rotational positioning.

The shown example calculation or the above-specified formula, respectively, is to thereby only be seen as an example; all of the methods for determining a correlation, which illustrate the degree of the correlation or of a context between the value sequences, which are to be compared, respectively (via the time sequence as representation for a complete rotation, for instance), are comprised by the invention, wherein other methods for the (complex) pattern identification, based on the overall signal or a partial signal or the like are also possible in addition to correlation methods. The value 10 (as resolution for a complete rotation in the illustrated time sequence) in the instant case must also be considered to be highly simplified and as an example; in the preferred case, at least 100 individual values would have to be identified around a tube head periphery and would then have to be correlated accordingly; preferred embodiments thereby schedule a time of individual values >200, ideally also >300, so as to provide for a position determination, which is as accurate and insensitive to errors as possible.

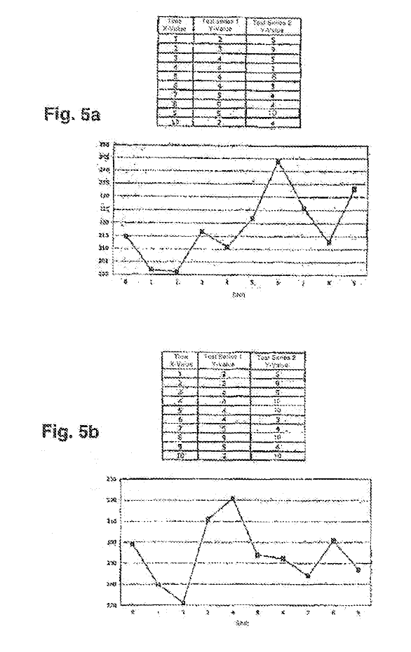

It is clarified in this context and with reference to examples 5a and 5b, how high the error tolerance of the instant procedure is in order to determine a rotational position shift by means of correlation of the respective signal sequences: Deviating from the idealized measuring value sequence of FIG. 3b, the fifth and the ninth measuring value was thereby specifically falsified in FIG. 5a (in accordance with the points in time 5 and 9) (the test series 1 still corresponds to the idealized value sequence Y value in FIG. 3b in this respect), wherein the corresponding graphic indicates the sequence of the correlation value r(n), analogous to FIG. 4. It follows that the maximum correlation can still be identified clearly and unambiguously at the point in time 6 even in the case of two values at the time positions 5 and 9, which clearly deviate from the idealized sequence, so that a clear and correct relative positioning of the control of unit 12 takes place even under these problematic conditions. This determination only becomes faulty when, see FIG. 5b, which shows a tolerance limit in this respect, four of the ten measuring values (here the time position 4, 5, 8, 10) clearly deviate from the ideal measuring values. However, there is an expectation that a correct determination of a maximum correlation can also take place here during the actual operation in response to typically more than 100, preferably more than 300 quantified individual values around the tube head periphery.

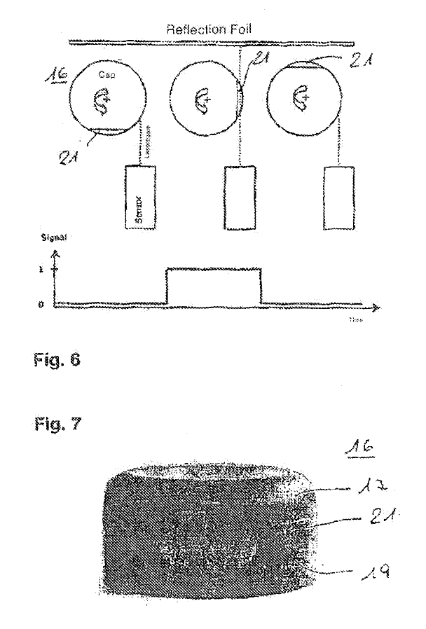

The above observation thus clarifies that the procedure according to the invention by means of correlation leads to good results even in response to a comparatively low (numerical) resolution or large measuring value deviations, respectively, and to a highly secured position and thus to a high production quality in particular in the advantageous manner according to the invention. As already explained, it is obvious thereby that an increase of the individual measurements increases the processing effort for the correlation on the one hand, but that a further increased production tolerance and positional accuracy can be obtained on the other hand. Vice versa, it becomes clear from this observation that the procedure with the existing weaknesses described in the state of the art according to FIG. 6, for example, is improved significantly and that it can be expected in this regard that the assembly processes of two tube partners can be carried out with a high quality by means of the instant invention, even under adverse conditions or in response to high tolerance demands, respectively.

While the above-described first embodiment has been described as device, it can equally be understood as explanation of a method claimed according to the invention, how a relative position of tube head and tube body takes place as partners, which are to be oriented relative to one another, by operating the arrangement according to FIG. 1.

Contrary to the above-described exemplary embodiment, the instant invention is thereby not limited to the active rotation of the tube head relative to the (stationary) tube body. Instead, the instant invention likewise comprises it to position a tube head in a predetermined manner in an otherwise known manner, which can be realized easily, to sense and move the tube body in its relative position by means of suitable sensor means and to likewise effect the desired rotationally positionally accurate orientation of the partners relative to one another.

For instance a marking, which is present on a tube body, is thereby advantageous for such a rotary-analogous measurement, as well as a label or similar marking, which is possibly already present, which can be sensed for determining a current tube position and which can be stored in a digitized manner as described above, so as to subsequently be correlated with a reference signal.

1-10. (canceled)

11. A device for the automatic rotational orientation of a tube head (16) relative to a preferably stationary tube body (14), comprising sensor means (18) for sensing a current rotated position of the tube head or tube body having a position indicator (21);
positioning means (12, 20), which interact with the sensor means and are designed to effect a rotary movement of the tube head or of the tube body in reaction to a control signal from a control unit (22), wherein the sensor means are designed to generate a sensing signal corresponding to a rotary movement of the tube head or tube body and the control unit has means for correlating (24) the sensing signal with a reference signal and for generating a control signal from a characteristic value corresponding to a degree of correlation, in particular a maximum correlation or minimum correlation, for the positioning means; and
the sensor means are designed for generating the reference signal by means of a reference body, which is provided in a predetermined rotated position, in particular reference tube head, and the reference signal is present in electronically stored form as predetermined signal sequence.

12. The device according to claim 11, wherein the sensor means is selected from the group consisting of an optically acting sensor, a capacitively acting sensor, an ultrasound sensor, and mixtures thereof, and are designed for generating the sensing signal via a time sequence, which corresponds to the rotary movement.

13. The device according to claim 11, wherein the sensor means are designed for digitizing and subsequent storing of the sensing signal as sequence of quantified individual signals.

14. The device according to claim 11, wherein the sensor means are designed such that at least 300 individual signals of the sensing signal are generated as basis for the correlation along the time sequence, which corresponds to a rotary movement of the tube head.

15. The device according to claim 11, wherein the means for correlating correlates the numerical determination of a correlation function of the sensing signal with the reference signal as well as for determining a characteristic value, which describes the correlation, in particular of a functional maximum or functional minimum, from the correlation function.

16. The device according to claim 15, wherein the control unit is designed such that a position of the functional maximum or functional minimum, respectively, determines the control signal for the rotary movement of the tube head or tube body in a time sequence.

17. The device according to claim 11, wherein the reference signal is specifically present for at least one tube head type.

18. A method for the rotational orientation of a tube head relative to a tube body comprising the steps:
sensing a rotated position of the tube head relative to the tube body and
carrying out a relative rotation of the tube head to the tube body as a function of the sensed rotated position, wherein the sensing of the rotated position encompasses the generation of an analog or digital sensing signal corresponding to a rotary movement of the tube head or tube body, over a time sequence, which corresponds to the rotary movement, the sensing signal is correlated with a predetermined reference signal and the rotated position is determined from a characteristic value, which describes the correlation, in particular maximum correlation or minimum correlation of the correlation, characterized in that the reference signal is generated by means of a reference body, which is preferably provided in a predetermined rotated position and is stored electronically.
